(19) United States
(12) Patent Application Publication
(10) Pub. No.: US 2026/0235554 A1
(43) Pub. Date: Aug. 13, 2026

(54) INSPECTION ASSISTANCE METHOD AND INSPECTION ASSISTANCE DEVICE

(71) Applicant: Hitachi, Ltd., Tokyo (JP)

(72) Inventors: Masanori KITAOKA, Tokyo (JP); Hirohisa MIZOTA, Tokyo (JP)

(73) Assignee: Hitachi, Ltd., Tokyo (JP)

(21) Appl. No.: 19/153,495

(22) PCT Filed: Apr. 22, 2024
(86) PCT No.: PCT/JP2024/015755

§ 371 Date: Aug. 4, 2025

(30) Foreign Application Priority Data
May 12, 2023 (JP) 2023-079232

(51) Int. Cl. G01N 29/04

(52) U.S. Cl. CPC G01N 29/04; G01N 2291/023; G01N 2291/0289

(57) ABSTRACT

In order to optimize an inspection period, an inspection assistance device includes performing: Step of calculating a flaw detection probability; Step of calculating a flaw size probability distribution over time using an inspection variation that has been input via a data input unit and an initial distribution of the flaw size probability distribution; and Step of determining an inspection period in a case where an area of a region where the flaw size probability distribution over time and a fracture probability overlap with each other exceeds a preset allowable risk; and Step of outputting the determined inspection period.

### TECHNICAL FIELD

The present invention relates to techniques of an inspection assistance method and an inspection assistance device.

### BACKGROUND ART

In order to maintain and manage social infrastructure equipment typified by power plants, railway trucks, etc., improvement of efficiency by advancement of non-destructive inspection technology is required. In these social infrastructure devices, soundness is guaranteed by periodic inspections performed at predetermined intervals. In general, it is defined that non-destructive inspections are performed at intervals that maximally consider the risk of each device. However, it is rare that flaws are detected in power plants, etc., and excessive inspections lead to the deterioration of economic efficiency. Therefore, it is required to determine inspection periods with reasonable indices.

In order to address such problem, for example, PTL1 describes a destructive evaluation analyzer, a destructive evaluation analysis system and a destructive evaluation analysis method comprising:
“an input unit configured to accept information related to a number of repetitions in which crack propagation analysis is repeatedly performed and to accept information on an interval between inspection durations of non-destructive inspections within an evaluation duration of the crack propagation analysis, a cost for the non-destructive inspection, a repair cost, an accident response cost and a crack detection probability calculation equation;
a stress calculation unit configured to calculate a stress near a tip of a crack generated in a structure subjected to neutron irradiation;
a stress intensity factor calculation unit configured to calculate a stress intensity factor based on a stress calculated by the stress calculation unit and crack propagation information related to the crack generated in the structure and a crack propagation rate;
a fracture toughness value derivation unit configured to calculate a fracture toughness value based on structure information including a Poisson's ratio and a longitudinal elastic modulus of the structure and information including a neutron irradiation dose of the structure;
a crack propagation amount calculation unit configured to calculate a crack propagation amount based on the crack propagation information, an evaluation duration of the crack propagation analysis, and time information relating to a time increment in the evaluation duration;
a fracture determination unit configured to compare a stress intensity factor calculated by the stress intensity factor calculation unit with a fracture toughness value calculated by the fracture toughness value derivation unit to determine the presence or absence of fracture;
an evaluation duration determination unit configured to determine whether a sum of time increments based on the time information and the number of repetitions of crack propagation analysis has reached the evaluation duration;
a crack detection determination unit configured to determine whether a crack is detected when the sum of the time increments reaches a time corresponding to the interval between the inspection durations;
a repetition determination unit configured to determine whether the number of times of the presence or absence of a crack determined by the crack detection determination unit during the duration until the non-destructive inspection and the duration from the end of the final non-destructive inspection to the end of the evaluation duration has reached the number of repetitions of the crack progress analysis;
a fracture probability calculation unit configured to calculate a fracture probability of the structure from a ratio of a number of times determined as fracture by the fracture determination unit to a number of repetitions of the crack progress analysis; and
an expense calculation unit for calculating a repair cost according to the ratio of the crack detected by the crack detection determination unit, the inspection cost according to the number of times of the non-destructive inspection and the inspection range, and the accident response cost according to the fracture probability”. (Refer to claim 1.)

### CITATION LIST

### Patent Literature

PTL 1: JP 6746512 B

### SUMMARY OF INVENTION

### Technical Problem

In the technique described in PTL 1, an accident response cost using a flaw detection probability by a non-destructive inspection and an inspection interval as inputs are calculated by probabilistic fracture analysis. However, although the technology described in PTL 1 enables evaluation of an inspection interval in consideration of economic efficiency, the inspection interval is input by a user and is not determined by the system.

In general, in order to determine an inspection interval, it is necessary to predict a period when a flaw may become a serious risk from prediction of propagation using an initial distribution of the flaw. However, since it is rare to detect a flaw, it is difficult to calculate a risk by utilizing information on flaw detection.

The present invention has been made in view of such a background, and an object of the present invention is to optimize inspection intervals.

### Solution to Problem

In order to solve the above-mentioned problem, the present invention includes executing the following steps by an inspection assistance device:
a first step of calculating a flaw detection probability;
a second step of calculating a flaw size probability distribution over time using an inspection variation that has been input via an input unit and an initial distribution of the flaw size probability distribution; and
a third step of determining an inspection period in a case where an area of a region where the flaw size probability distribution over time and a fracture probability overlap with each other exceeds a preset allowable risk; and
a fourth step of outputting the determined inspection period.

Other solutions will be appropriately described in the embodiments.

### Advantageous Effects of Invention

According to the present invention, inspection intervals can be optimized.

### BRIEF DESCRIPTION OF DRAWINGS

FIG. 1 is a functional block diagram illustrating a configuration example of the inspection assistance device according to a first embodiment.

FIG. 2 is a hardware configuration diagram of the inspection assistance device according to the first embodiment.

FIG. 3 is a flowchart illustrating a procedure of the inspection assistance method according to the first embodiment.

FIG. 4 is a conceptional diagram illustrating an example of the model for calculating a flaw detection probability in the first embodiment.

FIG. 5 is a conceptual diagram illustrating a flaw detection probability according to the present embodiment.

FIG. 6 is a flowchart illustrating the details of calculation of a flaw size probability distribution over time and determination of an inspection interval in the first embodiment.

FIG. 7 is a conceptual diagram illustrating a flaw size probability distribution over time according to the first embodiment.

FIG. 8A is a conceptual diagram (Part 1) illustrating an example of Bayesian estimation of a flaw size probability distribution after inspection according to the first embodiment.

FIG. 8B is a conceptual diagram (Part 2) illustrating an example of Bayesian estimation of a flaw size probability distribution after inspection according to the first embodiment.

FIG. 9 is a schematic diagram illustrating a procedure for determining an inspection interval.

FIG. 10 is a conceptual diagram illustrating a flaw size probability distribution over time according to the second embodiment.

FIG. 11 is a flowchart illustrating a procedure of an inspection assistance method according to the second embodiment.

FIG. 12 is a flowchart illustrating the details of calculation of a flaw size probability distribution over time and determination of an inspection interval in the second embodiment.

FIG. 13 is a flowchart illustrating the detailed calculation procedure for calculating a flaw size probability distribution over time in the third embodiment.

FIG. 14 is a diagram illustrating an example of an output screen.

### DESCRIPTION OF EMBODIMENTS

Next, modes for carrying out the present invention (referred to as “embodiments”) will be described in detail with reference to the drawings as appropriate. In the drawings, the same components are denoted by the same reference numerals, and the detailed description of overlapping components is omitted.

### First Embodiment

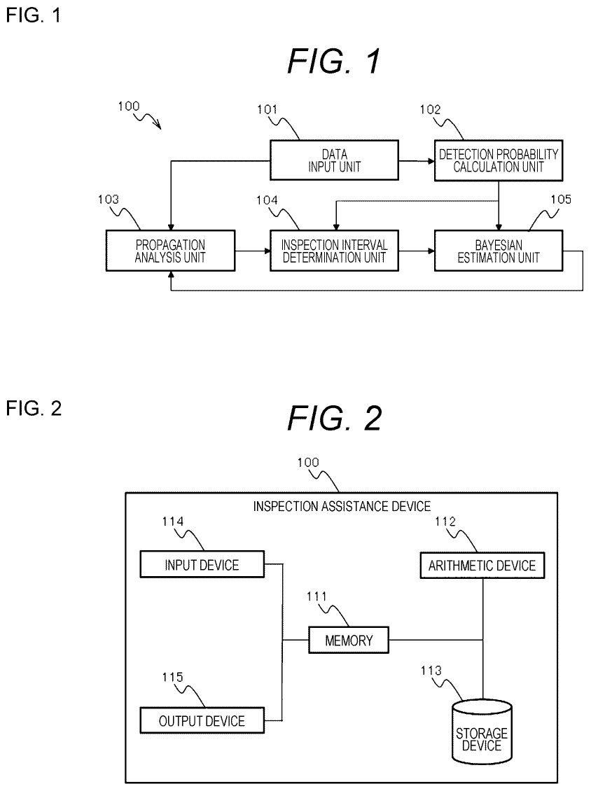

An inspection assistance method according to the first embodiment of the present invention will be described with reference to FIGS. 1 to 9.

### <Inspection Assistance Device 1>

FIG. 1 is a functional block diagram illustrating a configuration example of an inspection assistance device 1 according to the first embodiment. FIG. 1 illustrates an outline of processing performed by a data input unit 101 to a Bayesian estimation unit 105. The details of the processing performed by the data input unit 101 to the Bayesian estimation unit 105 will be described later.

The data input unit 101, which is an input unit, includes an interface that receives inputs of an inspection variation, a material variation, an initial flaw size probability distribution and an allowable risk. The inspection variation and material variation that have been input are sent to a detection probability calculation unit 102.

The detection probability calculation unit 102 calculates a flaw detection probability (the curve 301 in FIG. 5) and a flaw non-detection probability (the curve 302 in FIG. 5) by non-destructive inspection. Hereinafter, the flaw detection probability is appropriately referred to as a detection probability, and the flaw non-detection probability is appropriately referred to as a non-detection probability. The detection probability calculation unit 102 may calculate only the detection probability. The detection probability of the non-destructive inspection (the curve 301 in FIG. 5) calculated by the detection probability calculation unit 102 is sent to the Bayesian estimation unit 105. The detection probability is a probability that a flaw is detected by an inspection, and the non-detection probability is a probability that a flaw is not detected by an inspection.

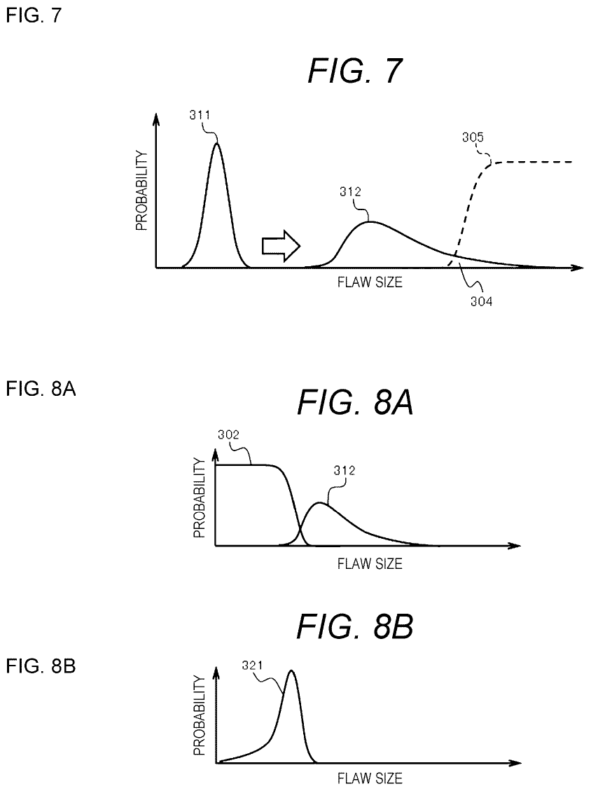

The material variation and the initial flaw size probability distribution that have been input to the data input unit 101 are sent to a propagation analysis unit 103. Then, the propagation analysis unit 103 calculates a flaw size probability distribution over time (the curve 312 in FIG. 7). The flaw size probability distribution over time (the curve 312 in FIG. 7) calculated by the propagation analysis unit 103 is sent to an inspection interval determination unit 104. The flaw size probability distribution is a probability distribution relating to the size of a flaw occurred.

The inspection interval determination unit 104, which is an inspection period determination unit, an output processing unit and an updating unit, determines an inspection interval, which is an inspection period. The inspection interval is an interval from when a certain inspection is performed to when the next inspection is performed. In a case where an inspection to be performed is the first inspection from the start of the inspection, it is an interval from the start of the inspection to the time when the first inspection is performed. At this time, the inspection interval determination unit 104 calculates an estimated fracture probability (the region 304 in FIG. 7) based on a detection probability of a flaw 203 (the curve 301 in FIG. 5) and a flaw size probability distribution over time (the curve 312 in FIG. 7). Then, the inspection interval determination unit 104 compares the estimated fracture probability (the region 304 in FIG. 7) with the allowable risk input by the data input unit 101 to determine the inspection interval. The estimated fracture probability is a probability that an object currently being inspected will be broken due to a flaw.

The Bayesian estimation unit 105 performs Bayesian estimation of a flaw size probability distribution after inspection (the curve 321 in FIG. 8B) on the basis of a non-detection probability (the curve 302 in FIG. 5) and the flaw size probability distribution over time (the curve 312 in FIG. 7). The flaw size probability distribution after inspection (the curve 321) is sent to the propagation analysis unit 103.

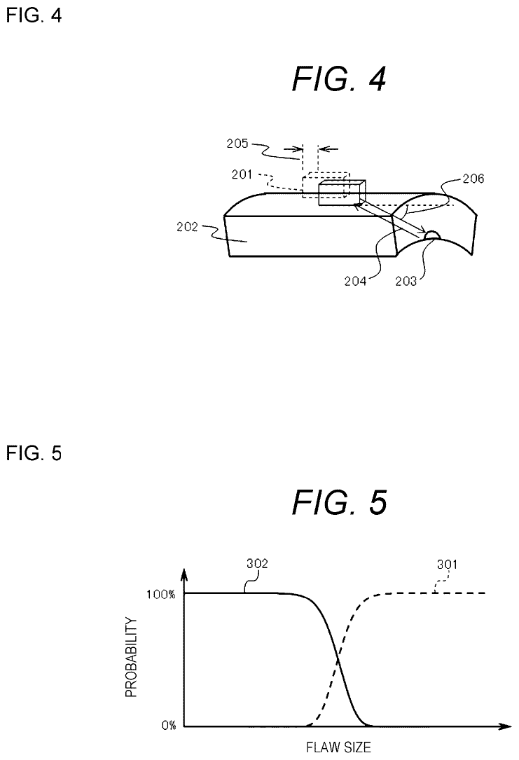

Then, the above-mentioned processing is repeatedly executed, and the inspection interval is determined repeatedly until the sum of the respective inspection intervals exceeds an operation duration of an inspection target 202 (see FIG. 4). The operation duration is, for example, a duration from the inspection target 202 to the completion of the guarantee of the inspection target 202.

### <Hardware Configuration Diagram>

FIG. 2 is a hardware configuration diagram of the inspection assistance device 100 according to the first embodiment.

The inspection assistance device 100 includes a memory 111 configured by a RAM, etc., and an arithmetic device 112 configured by a CPU, a GPU, etc. Furthermore, the inspection assistance device 100 includes a storage device 113 configured by an HD, an SSD, etc. Moreover, the inspection assistance device 100 includes an input device 114 such as a keyboard and a mouse, and an output device 115 such as a display.

Then, a program stored in the storage device 113 is loaded into the memory 111, and the loaded program is executed by the arithmetic device 112. By doing so, the detection probability calculation unit 102 to the Bayesian estimation unit 105 illustrated in FIG. 1 are embodied. Incidentally, the data input unit 101 in FIG. 1 corresponds to the input device 114 in FIG. 2.

### <Flowchart>

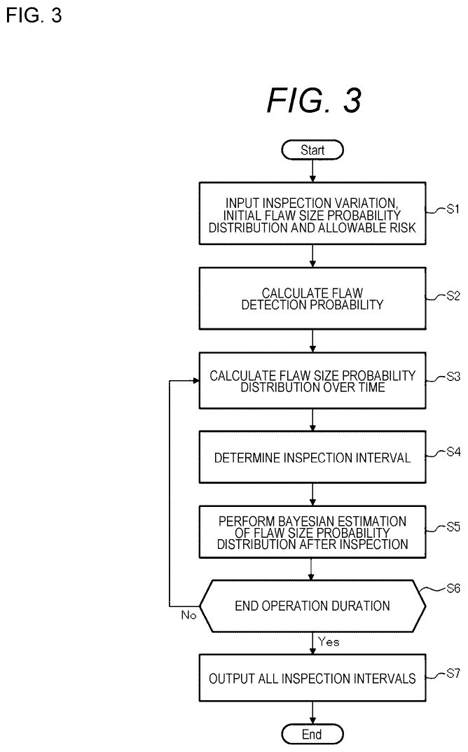

FIG. 3 is a flowchart illustrating a procedure of the inspection assistance method according to the first embodiment. The inspection assistance method according to the present embodiment will be described with reference to FIG. 3 while referring to FIG. 1.

As illustrated in FIG. 3, first, a user inputs an inspection variation, an initial flaw size probability distribution and an allowable risk via the data input unit 101 (S1). These pieces of data are stored in the memory 111 (see FIG. 2) or a hard disk, and are used in the subsequent steps. The details of the inspection variation and the initial flaw size probability distribution will be described later.

Subsequently, the detection probability calculation unit 102 calculates the detection probability of a target flaw 203 (S2: the first step).

Step S2 will be described with reference to FIGS. 4 and 5.

FIG. 4 is a conceptional diagram illustrating an example of a model for calculating a flaw detection probability in the first embodiment.

FIG. 4 illustrates a case of ultrasonic wave flaw detection for a crack-like defect as a specific example of a flaw inspection. Other non-destructive inspection methods such as Eddy Current Testing and Radiographic Testing can also be modeled by similar methods.

In the example illustrated in FIG. 4, an ultrasonic probe 201 is installed on the inspection target 202, and an ultrasonic wave 204 is transmitted toward the flaw 203. The ultrasonic wave 204 is reflected by the flaw 203, and the reflected ultrasonic wave 204 is received by the ultrasonic probe 201. At this time, whether the flaw 203 is detected or not depends on the size of the flaw 203 and the inspection variation. As in the example illustrated in FIG. 4, the inspection variation includes a variation 205 in the installation position of the ultrasonic probe 201, a variation 206 in the ultrasonic wave transmission direction, etc. The inspection variation also includes a variation in a material constant such as a sonic speed inside the inspection target 202.

FIG. 5 is a conceptual diagram illustrating a flaw detection probability according to the present embodiment.

In the graph illustrated in FIG. 5, the horizontal axis represents the size of the flaw 203 (see FIG. 4), and the vertical axis represents the probability. The detection probability is a curve indicated by a curve 301 for the flaw size “a”. The detection probability is expressed as “POD(a)”. Incidentally, POD is an abbreviation of Probability of Detection. Furthermore, the non-detection probability becomes a curve as illustrated in a curve 302 and is expressed as “1-POD(a)”.

The curve 301 of the detection probability can be obtained using a physical simulation of a non-destructive inspection or an experimental result. For example, in the physical simulation illustrated in FIG. 4, the detection probability calculation unit 102 randomly samples one value for each of items of the size of the flaw 203 and the inspection variation. Then, the detection probability calculation unit 102 performs physical simulation under that conditions. The inspection variation includes the variation 205 in the installation position of the ultrasonic probe 201 and the variation 206 in the ultrasonic wave transmission direction illustrated in FIG. 4, and variations in material constants such as a sonic speed of the inspection target 202, etc. The detection probability calculation unit 102 performs random sampling and simulation a plurality of times, and calculates a detection probability from a calculated detection signal intensity. As a method for estimating a detection probability curve 301 from a detection intensity of the ultrasonic wave 204, maximum likelihood estimation methods such as a Hit/Miss method are known.

The description returns to FIG. 3.

After Step S2, the propagation analysis unit 103 calculates a flaw size probability distribution over time (S3: the second step). Specifically, in Step S3, the propagation analysis unit 103 calculates the flaw size probability distribution over time using the inspection variation and an initial distribution of the flaw size probability distribution (an initial flaw size probability distribution). In Step S3, a fatigue crack will be described as an example of the flaw 203. In general, it is known that, in a stable crack growth stage (an Jib stage of fatigue crack propagation), a crack propagates and grows with respect to a repeating stress according to the law shown in Equation (1) called the Paris' law.

$$da / dt = {C ( Δ K )}^{m} / τ \qquad ( 1 )$$

In Equation (1), a is a crack size, t is a lapse time, T is a stress repetition interval, C and m are material constants, and AK is a stress intensity factor range. AK is obtained by a calculation method such as Finite Element Method (FEM). Therefore, in the present embodiment, the change in flaw size probability distribution over time is deemed to be a change in flaw size probability distribution over time relating to a crack-like defect according to the Paris' law. In this way, the inspection assistance method of the present embodiment can be applied to a general crack as the flaw 203.

After Step S3, the inspection interval determination unit 104 determines an inspection interval (S4: the third step). An area of the region 304 surrounded by the curve 312 (the flaw size probability distribution over time) and the curve 305 (the fracture probability) in FIG. 7 represents the estimated fracture probability of the inspection target 202 after t hours have elapsed. The fracture probability indicates the size of the flaw and the probability at which the inspection target 202 (see FIG. 4) is destructed. t represents a time that has elapsed from the previous inspection. The inspection interval determination unit 104 updates t at predetermined intervals to update the flaw size probability distribution over time indicated by the curve 312. Then, the inspection interval determination unit 104 calculates the estimated fracture probability indicated by the region 304 in FIG. 7 each time the flaw size probability distribution indicated by the curve 312 is updated. The fracture probability is a probability that the inspection target 202 is broken with respect to the flaw size. Note that the estimated fracture probability indicated by the region 304 is an area of a region where the flaw size probability distribution over time and the fracture probability overlap. The details of FIG. 7 will be described later.

### (Details of Steps S3 and S4)

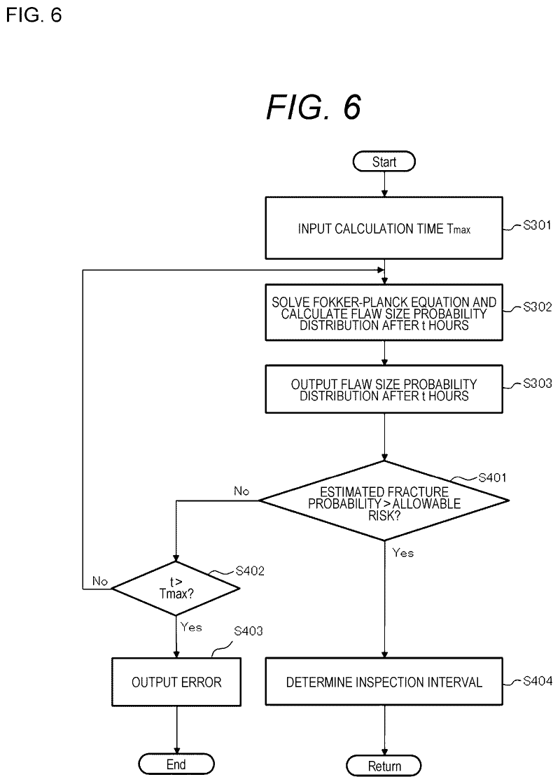

FIG. 6 is a flowchart illustrating the details of Step S3 (calculation of a flaw size probability distribution over time) and Step S4 (determination of an inspection interval) in FIG. 3.

First, a user inputs a calculation time Tmax as an evaluation parameter (S301).

Subsequently, the propagation analysis unit 103 solves the following Fokker-Planck equation to calculate the flaw size probability distribution “p(a, t)” after a calculation time of (t) hours has lapsed (S302).

The propagation analysis unit 103 repeats this processing until t>Tmax. By doing so, the propagation analysis unit 103 solves the Fokker-Planck equation and calculates the flaw size probability distribution until after the time Tmax. In the present embodiment, C or AK of the Paris' law shown in Equation (1) includes a noise component of the ultrasonic wave 204 reflecting a variation in material constant or a variation in repeated stress. In view of this fact, assuming a Markov property with respect to a noise of the ultrasonic wave 204, a Fokker-Planck equation, which is a stochastic differential equation corresponding to the Paris' law, is obtained (Equation (2)).

$$da = μ ( a , t ) dt + σ ( a , t ) dWt \qquad ( 2 )$$

In Equation (2), μ(a, t) is an average value of the right side of the Paris' law (Equation (1)), σ(a, t) is a standard deviation of the right side of the Paris' law, and Wt is a standard Wiener process. When the Ito integral is used, the Fokker-Planck equation is expressed by the following Equation (3).

$$\begin{matrix}[ Mathematical Equation 1 ] & \\ \frac{\partial p ( a , t )}{\partial t} = - \frac{\partial }{\partial a} [ μ ( a , t ) p ( a , t ) ] + \frac{1}{2} \frac{{\partial }^{2}}{\partial {a}^{2}} [ {σ ( a , t )}^{2} p ( a , t ) ] & ( 3 )\end{matrix}$$

When the Stratonovich integral is used, the Fokker-Planck equation is expressed as the following Equation (4).

$$\begin{matrix}[ Mathematical Equation 2 ] & \\ \frac{\partial p ( a , t )}{\partial t} = - \frac{\partial }{\partial a} [ μ ( a , t ) p ( a , t ) ] - \frac{1}{2} \frac{\partial }{\partial a} [ \frac{\partial σ ( a , t )}{\partial a} σ ( a , t ) p ( a , t ) ] + \frac{1}{2} \frac{{\partial }^{2}}{\partial {a}^{2}} [ {σ ( a , t )}^{2} p ( a , t ) ] & ( 4 )\end{matrix}$$

In the present embodiment, either integration method may be used.

Then, the propagation analysis unit 103 outputs the flaw size probability distribution after t hours (calculation time) as a solution of the Fokker-Planck equation (S303).

As mentioned above, the propagation analysis unit 103 calculates the flaw size probability distribution over time by solving a Fokker-Planck equation, which is a flaw propagation equation in which a flaw size is a continuous probability variable, in Step S3. This makes it possible to analytically solve a flaw extension.

Next, the inspection interval determination unit 104 determines whether or not the estimated fracture probability is larger than an allowable risk (S401). The estimated fracture probability will be described later.

When the estimated fracture probability is equal to or less than the allowable risk (S401→No), the inspection interval determination unit 104 determines whether or not the calculation time (t) is larger than Tmax (S402).

When the calculation time (t) is equal to or less than Tmax (S402→No), the inspection assistance device 100 updates the calculation time (t) and returns the processing to Step S302. When the calculation time (t) is larger than Tmax (S402→Yes), the inspection interval determination unit 104 outputs an error (S403) and stops the processing.

On the other hand, when the estimated fracture probability is larger than the allowable risk (S401→Yes), the inspection interval determination unit 104 determines an inspection interval (S404). The calculation time (t) is set to “0” when the processing of FIG. 6 is started. Then, the calculation time (t) is updated each time when the determination is “No” in Step S402. The update width varies depending on the inspection target 202, and is, for example, in units of one day. In Step S404, the inspection interval determination unit 104 determines, as an inspection interval, a calculation time (t−1=T) obtained by subtracting 1 from the value of the calculation time (t) when Step S404 is executed. Thereafter, the inspection assistance device 100 advances the processing to Step S5 in FIG. 3.

In the processing of FIG. 6, Steps S301 to S303 are the processing of Step S3 of FIG. 3, and Steps S401 to S404 are the processing of Step S4 of FIG. 3.

Next, the processing of FIG. 6 will be described with reference to FIG. 7.

FIG. 7 is a conceptual diagram illustrating a flaw size probability distribution over time according to the first embodiment.

In the graph illustrated in FIG. 7, the horizontal axis represents a flaw size, and the vertical axis represents a probability. A curve 311 is a flaw size probability distribution (prior probability distribution). When the execution of Step S3 is the first time, the prior probability distribution indicated by the curve 311 is the initial flaw size probability distribution that is input in Step S1. When the execution of Step S3 is the second time or later, the prior probability distribution indicated by the curve 311 is the flaw size probability distribution after inspection that has undergone Bayesian estimation in Step S5, which will be mentioned later. A curve 312 is a flaw size probability distribution after a calculation time of “T=t−1” (<Tmax) hours, which is the inspection interval in Step S404 in FIG. 6, has elapsed. Incidentally, the curve 312 is a curve obtained as a result of time-integrating the Fokker-Planck equation mentioned above with the initial flaw size probability distribution indicated by the curve 311 as an initial value. That is, the curve 312 is the flaw size probability distribution that is output in Step S302 of FIG. 6. Furthermore, the curve 305 is the fracture probability of the inspection target 202 with respect to the flaw size “a”. The fracture probability represented by the curve 305 is a probability that fracture occurs in the inspection target 202 with respect to the size of the flaw 203. The curve 305 can be obtained by a calculation method such as FEM. The details of the region 304 will be described later. Incidentally, the fracture probability (the curve 305) is different from the detection probability (the curve 301) illustrated in FIG. 5.

Then, the inspection interval determination unit 104 compares the allowable risk that has been input in Step S1 with the estimated fracture probability after a calculation time of “T” hours has lapsed (Step S401 in FIG. 6). This comparison is made each time the flaw size probability distribution indicated by the curve 312 is updated. Furthermore, the inspection interval determination unit 104 is deemed to be a calculation time when the allowable risk and the estimated fracture probability are equal, or an inspection-inspection interval between an inspection in which the maximum calculation time is the n-th inspection and the n−1-th inspection when the fracture probability does not exceed the allowable risk (Step S404 in FIG. 6). n is a number of times of the processing in Step S3.

That is, when the estimated fracture probability indicated by the region 304 has been input in Step S1 and has exceeded the set allowable risk, the previous calculation time “T” is output as the inspection interval (that is, the period when the next inspection is performed).

The description returns to FIG. 3.

Subsequently, the Bayesian estimation unit 105 performs Bayesian estimation of the flaw size probability distribution after inspection (S5: fifth step).

FIGS. 8A and 8B are conceptual diagrams illustrating an example of Bayesian estimation of a flaw size probability distribution after inspection according to the first embodiment. The flaw size probability distribution before inspection is p(a|before inspection)=p(a, T). The flaw size probability distribution before inspection is a flaw size probability distribution over time (the curve 312) at the above-described calculation time of “T=t−1”.

As illustrated in FIG. 8B, the flaw size probability distribution after inspection (the curve 321) when the flaw 203 is not detected in the inspection is expressed by the following Equation (5) according to the Bayes' theorem. In Equation (5), the flaw size probability distribution after inspection (the curve 321) is calculated on the basis of the non-detection probability of the flaw 203 (the curve 302) and the flaw size probability distribution before inspection (the curve 312), as illustrated in FIG. 8A. The non-detection probability (the curve 302) of the flaw 203 is calculated in Step S1 of FIG. 3.

$$p ( a \vert after inspection ) = A ( 1 - POD ( a ) ) p ( a \vert before inspection ) \qquad ( 5 )$$

In Equation (5), POD(a) is a detection probability of the flaw 203 in a case where the flaw size is “a” (the curve 301 in FIG. 5). That is, “1−POD(a)” indicates the non-detection probability of the flaw 203 (the curve 302 in FIG. 5). Furthermore, “p(a|before inspection)” indicates a flaw size probability distribution before inspection. The flaw size probability distribution before inspection is a flaw size probability distribution over time immediately before an inspection. Furthermore, A is a normalization constant for setting a total probability of “p(a|after inspection)” to be “1”. By doing so, the flaw size probability distribution after inspection is as the curve 321 in FIG. 8B.

As described above, in Step S5, the Bayesian estimation unit 105 estimates the flaw size probability distribution after inspection by Bayesian estimation. For the Bayesian estimation, the flaw detection probability (POD(a)) calculated in Step S2 and the flaw size probability distribution over time calculated in Step S3 are used.

The description returns to FIG. 3.

Subsequently, the inspection assistance device 1 determines whether or not the total of the inspection intervals has ended a targeted operation duration (S6). When the total of the inspection intervals has not exceeded the targeted operation duration (S6→No), the inspection assistance device 1 sets the flaw size probability distribution after inspection (the curve 321 in FIG. 8B) as the initial flaw size probability distribution (the curve 311 in FIG. 7). Thereafter, the inspection assistance device 1 returns the processing to Step S3. The initial flaw size probability distribution is an initial distribution of the flaw size probability distribution over time used in Step S3. In this manner, the inspection assistance device 1 sequentially determines the inspection intervals by setting the flaw size probability distribution after inspection calculated in Step S3 as the initial distribution of the flaw size probability distribution over time.

Thereafter, the inspection assistance device 1 executes Steps S3, S4 and S5 using the flaw size probability distribution after inspection (the curve 321) as the initial flaw size probability distribution (the curve 311 in FIG. 7). By doing so, the inspection interval determination unit 104 determines the next inspection interval. When the total of the inspection intervals exceeds a targeted operation duration (S6→Yes), the inspection interval determination unit 104 outputs all the determined inspection intervals (S7: the fourth step) and completes the procedure.

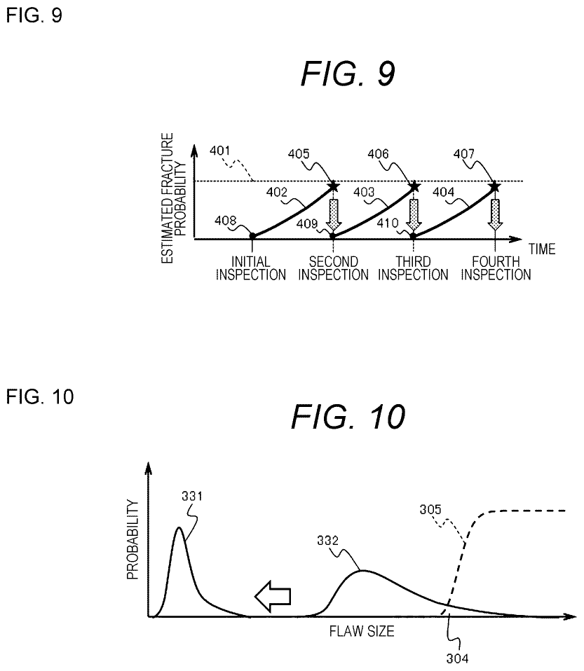

FIG. 9 is a schematic diagram illustrating a procedure for determining the inspection interval.

Hereinafter, the step numbers are the step numbers in FIG. 3.

The horizontal axis of the graph illustrated in FIG. 9 is the elapsed time from the start of an operation of an object, and the vertical axis is an estimated fracture probability at each elapsed time. A broken line 401 indicates the allowable risk that has been input in Step S1. Furthermore, curves 402 to 404 are the estimated fracture probabilities calculated in Step S4. Furthermore, points 405 to 407 are estimated fracture probabilities calculated using the respective flaw size probability distributions before inspection p(a|before inspection). Moreover, the points 408 to 410 represent estimated fracture probabilities calculated using the respective flaw size probability distributions immediately after inspection p(a|before inspection). The reason why the estimated fracture probabilities are low values at the points 408 to 410 is as follows. That is, since the flaw size probability distribution after the Bayesian estimation is reset as the initial flaw size probability distribution, the estimated fracture probability indicated by the region 304 illustrated in FIG. 7 has a low value.

According to the first embodiment, the flaw size probability distribution after inspection utilizing the non-detection probability of the flaw 203 is calculated even for a target in which the flaw 203 is rarely detected. Then, an inspection interval is determined by a reasonable index based on the flaw size probability distribution after inspection. That is, according to the first embodiment, it is possible to rationally determine the next inspection interval by utilizing the information that the flaw detection has not been performed in a periodic inspection for the inspection target in which detection of a flaw is rare. Furthermore, the Bayesian estimation of the flaw size probability distribution after inspection is performed in Step S5, and the flaw size probability distribution after inspection which has undergone the Bayesian estimation becomes a new initial flaw size probability distribution. In this way, a plurality of inspection intervals can be determined. Then, by undergoing Bayesian estimation, an event in which no flaw was detected as a result of the inspection can be reflected in the next inspection.

### Second Embodiment

Next, an inspection assistance method according to the second embodiment of the present invention will be described with reference to FIG. 10. In FIG. 10, description of similar processing to that in FIG. 7 is omitted.

FIG. 10 is a conceptual diagram illustrating a flaw size probability distribution over time according to the second embodiment.

In the first embodiment, in Step S5, the Bayesian estimation unit 105 performs Bayesian estimation of the flaw size probability distribution after inspection according to Equation (5). On the other hand, in the second embodiment, in a case where the flaw 203 is not detected even if the inspection is performed a predetermined number of times at each inspection timing, the inspection assistance device 1 calculates the flaw size probability distribution after inspection by changing the scale parameter “a0” of Equation (6).

Furthermore, in the second embodiment, it is assumed that the flaw size probability distribution follows the Weibull distribution. The curve 331 in FIG. 10 is an initial flaw size probability distribution that becomes the Weibull distribution, and is expressed by Equation (6). The reason why the Weibull distribution is used is that it is easy to update the flaw size probability distribution. The flaw size probability distribution may not be limited to the Weibull distribution as long as the flaw size probability distribution can be updated.

$$\begin{matrix}[ Mathematical Equation 3 ] & \\ p ( a , t = O ) = \frac{β}{{a}_{O}} {( \frac{a}{{a}_{O}} )}^{β - 1} exp [ - {( \frac{a}{{a}_{O}} )}^{β} ] & ( 6 )\end{matrix}$$

In Equation (6), “β” is a predetermined shape parameter, and “a0” is a predetermined scale parameter.

Furthermore, in FIG. 10, the curve 332 is a flaw size probability distribution after a calculation time of “T” hours has lapsed (a flaw size probability distribution over time) having the initial flaw size probability distribution indicated by the curve 331 as an initial value.

That is, in the second embodiment, it is assumed that the initial flaw size probability distribution is deemed to be incorrect when a calculation result is such that the flaw 203 is continuously undetected even if the inspection is performed a predetermined number of times. That the flaw 203 is continuously undetected even the inspection is performed a certain number of times means that the detection probability during inspection described later does not reach the upper limit detection probability “α”. Therefore, the propagation analysis unit 103 changes the scale parameter “a0” of Equation (6) and performs processing of the flaw size probability distribution over time again. An open arrow illustrated in FIG. 10 indicates that the initial flaw size probability distribution (the curve 331) is changed in a case where the detection probability during inspection does not reach the upper limit detection probability “α”. Incidentally, the detection probability during inspection is a probability that a flaw is detected during an inspection.

### (Flowchart)

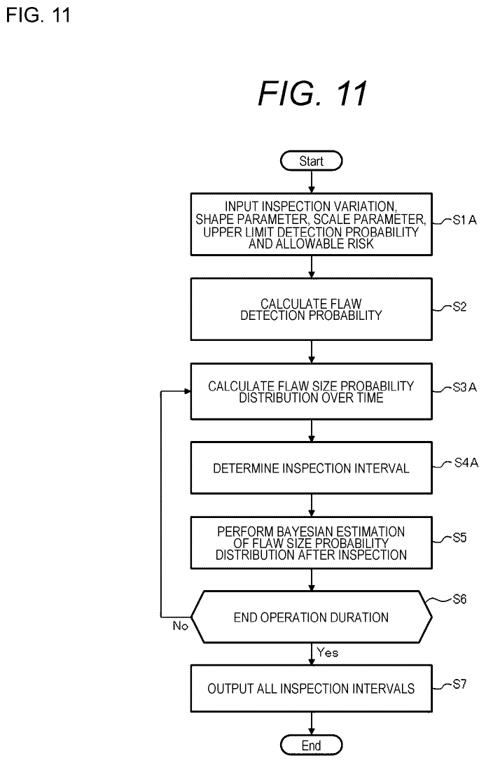

The above-mentioned processing will be described with reference to FIG. 11.

FIG. 11 is a flowchart illustrating a procedure of the inspection assistance method according to the second embodiment. In FIG. 11, similar processing to those in FIG. 3 is denoted by identical step numbers, and the descriptions thereof are omitted.

First, in Step S1A, instead of the initial flaw size probability distribution, the shape parameter “β”, the scale parameter “a0”, and the upper limit detection probability “α” are input.

Then, Steps S3A and S4A are performed.

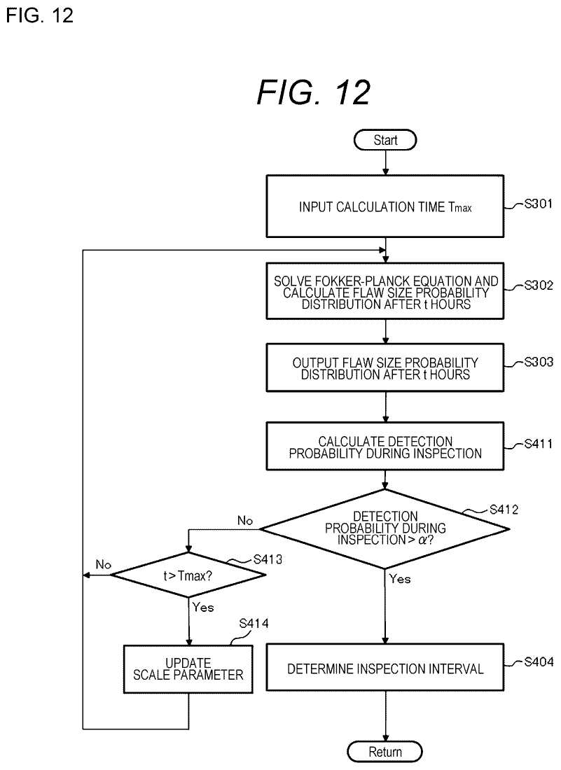

FIG. 12 is a diagram illustrating the details of Steps S3A and S4A of FIG. 11.

The processing from Steps S301 to S303 is the same as the processing illustrated in FIG. 6, except that the initial flaw size probability distribution is the Weibull distribution with a shape parameter of “β” and a scale parameter of “a0”.

Furthermore, after Step S303, the inspection interval determination unit 104 determines a detection probability during inspection (S411).

The detection probability (the curve 301 in FIG. 5) calculated in Step S2 is POD(a), and the flaw size probability distribution over time (the curve 332) calculated in Steps S3 and S4 before the inspection is p (a|before inspection). Then, the detection probability during inspection of the flaw 203 is expressed by the following Equation (7). The detection probability during inspection is a probability that a flaw having a certain size is detected when an inspection is performed.

$$\begin{matrix}[ Mathematical Equation 4 ] & \\ {\int }_{0}^{∞} POD ( a ) p ( a \vert before ) da & ( 7 )\end{matrix}$$

Next, the inspection interval determination unit 104 determines whether the detection probability during inspection expressed by Equation (7) is larger than the upper limit detection probability “α” (S412: the sixth step).

When the detection probability during inspection is less than the upper limit detection probability “α” (S412→No), the inspection interval determination unit 104 determines whether or not the calculation time (t) is larger than Tmax (S413). In the example illustrated in FIG. 12, Tmax input in Step S301 is used, but the present invention is not limited thereto.

When the calculation time (t) is equal to or less than Tmax (S413→No), the inspection assistance device 100 returns the processing to Step S302.

When the calculation time (t) is larger than Tmax (S413→No), the inspection interval determination unit 104 updates the scale parameter “a0” (S414). Then, the inspection assistance device 100 uses the Weibull distribution in which the scale parameter “a0” has been updated as the initial flaw size probability distribution, and performs the processing in and after Step S301.

On the other hand, when “Yes” is determined in step S412, the inspection interval determination unit 104 performs the processing of Step S404. The processing in step S404 is similar to the processing illustrated in FIG. 3.

When a flaw 203 is not detected even after a predetermined number of times, it is considered that the detection probability of the flaw 203 was actually smaller. That is, it is considered that the initial distribution of the flaw size probability distribution was incorrect. Therefore, the inspection interval determination unit 104 estimates the detection probability of the actual flaw 203 as the upper limit detection probability “α”. Then, the inspection interval determination unit 104 repeats the calculation of p(a|before inspection) while changing the scale parameter “a0” so that the value of Equation (7) becomes equal to a or equal to or greater than a. That is, the inspection interval determination unit 104 changes the initial flaw size probability distribution by changing the scale parameter “a0” of the Weibull distribution, and performs the processing of Step S3 and the subsequent steps again. In this way, the propagation analysis unit 103 updates the initial distribution of the flaw size probability distribution. Using this updated initial flaw size probability distribution, the propagation analysis unit 103 calculates a flaw size probability distribution after a calculation time of “T” hours has lapsed (the curve 332 in FIG. 10) in Step S404, and estimates p(a|after inspection).

As described above, in the second embodiment, in a case where the detection probability during inspection does not reach the upper limit detection probability, which is a predetermined probability, even if the inspection is performed a predetermined number of times in Step S4, the initial flaw size probability distribution is changed. In particular, by using the Weibull distribution as the flaw size probability distribution, it is possible to easily change the initial flaw size probability distribution only by changing the shape parameter “a0”.

The steps other than Steps S1 and S5 are the same as those in the first embodiment. Incidentally, as an application of the present embodiment, instead of the Weibull distribution, another probability distribution in which the initial flaw size probability distribution has a scale parameter can be assumed.

According to the second embodiment, in a case where a flaw 203 is not detected even after the inspection has been performed a predetermined number of times, the initial flaw size probability distribution is changed with deeming that the initial flaw size probability distribution is incorrect. In this way, the initial flaw size probability distribution can be generated by reflecting prior knowledge. This makes it possible to determine an inspection interval that is more realistic than that of the first embodiment.

### Third Embodiment

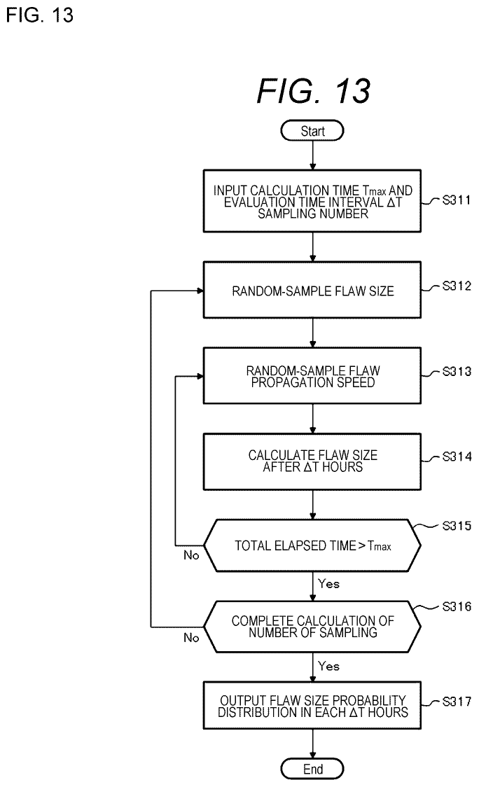

Next, the inspection assistance method according to the third embodiment of the present invention will be described with reference to FIG. 13.

In the first embodiment, in Step S3, the propagation analysis unit 103 calculates a solution of the Fokker-Planck equation, which is a stochastic differential equation. Then, the propagation analysis unit 103 calculates a flaw size probability distribution over time. In the present embodiment, the detailed calculation step of the stochastic differential equation in Step S3 is replaced with the Monte Carlo calculation.

FIG. 13 is a flowchart illustrating the detailed calculation procedure in Step S3 according to the third embodiment.

First, the propagation analysis unit 103 inputs a calculation time “Tmax”, an evaluation time interval “ΔT”, and a number of samplings of the Monte Carlo calculation via a data input unit 101 (S311).

Next, the propagation analysis unit 103 randomly samples a flaw size according to a flaw size probability distribution (S312). The flaw size probability distribution used has been set in advance. Although a normal distribution is used in the present embodiment, the Weibull distribution described above may also be used.

Subsequently, the propagation analysis unit 103 randomly samples the flaw propagation speed according to the probability distribution (S313). At this time, the propagation analysis unit 103 uses a normal distribution of an average μ(a, t) and a standard deviation σ(a, t) as described above, but is not limited to a normal distribution. Incidentally, t is a calculation time (t) used in the first embodiment.

Then, the propagation analysis unit 103 calculates the propagation of the flaw 203 on the basis of the propagation speed of the flaw size distribution obtained by random sampling in Step S313, and calculates the flaw size after ΔT hours (S314).

Subsequently, the propagation analysis unit 103 determines whether or not a sum of the elapsed times (a number of times of executions of ΔT×S314) exceeds a designated calculation time “Tmax” (S315).

When the designated calculation time “Tmax” has not been exceeded (S315→No), the propagation analysis unit 103 returns the processing to S313 and sequentially calculates the flaw size after the next ΔT hours.

When the sum of the elapsed times exceeds the designated calculation time “Tmax” (S315→Yes), the propagation analysis unit 103 completes one flaw sampling calculation.

Subsequently, the propagation analysis unit 103 determines whether or not the flaw sampling calculation (S313 to S315) for several times of the sampling designated in Step S311 has been completed (S316).

If not completed (S316→No), the propagation analysis unit 103 returns to the processing of step S312 and repeatedly executes steps S312 to S316.

When the number of calculations reaches the number of samplings and the propagation analysis unit 103 determines that the sampling calculations have been completed (S316→Yes), the propagation analysis unit 103 proceeds to the processing of Step S317.

In Step S317, the propagation analysis unit 103 outputs the flaw size probability distribution (experience distribution) for each ΔT time. In this way, the propagation analysis unit 103 calculates a flaw size probability distribution after T hours have passed, which is indicated by the curve 312 in FIG. 7. Incidentally, T corresponds to a calculation time (t−1) in the first and second embodiments. Then, the inspection assistance device 1 completes Step S3 of FIG. 3 and advances the processing to Step S4. The flaw size probability distribution for each ΔT hours which is output in Step S317 may be output as a histogram or may be output by being applied to an appropriate probability distribution.

The steps other than Step S3 are the same as those in the first embodiment. Incidentally, it is also possible to combine the second embodiment and the third embodiment.

In this way, the flaw size probability distribution over time is calculated by randomly sampling the flaw size and the flaw propagation speed in the third step.

According to the third embodiment, the flaw size probability distribution after a calculation time of “T” hours has lapsed indicated by the curve 312 in FIG. 7 is not analytically calculated as in the first embodiment, but is calculated by simulation by the Monte Carlo calculation. Incidentally, the calculation time “T” can be indicated by a total value of ΔT. By doing so, it is possible to calculate a flaw size probability distribution after a calculation time of “T” hours has lapsed without advanced mathematical knowledge.

### [Example of Output Screen]

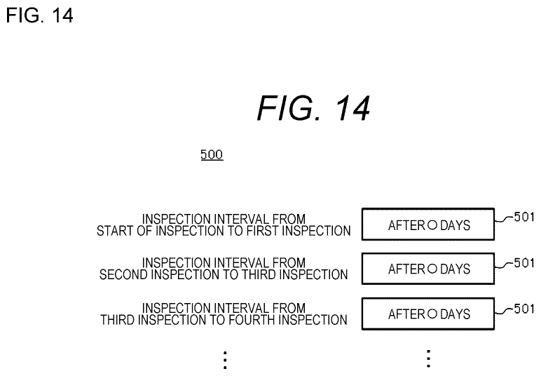

FIG. 14 is a diagram illustrating an example of an output screen according to the present embodiment.

An output screen 500 illustrated in FIG. 14 is a screen that is output to an output device 115 (see FIG. 2) in FIG. 3 or in Step S7 of FIG. 11.

The output screen 500 illustrated in FIG. 14 has an inspection interval output unit 501. The inspection interval output unit 501 outputs an interval from the previous time (or inspection start time) to when the next inspection is performed.

The present invention is not limited to the above-described embodiments, and includes various modifications. For example, the above-described embodiments have been described in detail for easy understanding of the present invention, and are not necessarily limited to those having all the described configurations. In addition, a part of the configuration of a certain embodiment can be replaced with the configuration of another embodiment, and the configuration of another embodiment can be added to the configuration of a certain embodiment. In addition, it is possible to add, delete or replace other configurations for part of the configuration of each embodiment.

Furthermore, in the present embodiment, the explanation has been made on the assumption that a crack is an example of the flaw 203, but the flaw 203 is not limited to a crack. For example, the present embodiment can be applied to general flaws that propagate over time such as pits. When a flaw other than a crack is used as the flaw 203, the methods, equations, etc. to be used can be those described in the present embodiment, except that the Paris' law indicated in Equation (1) is not used.

Furthermore, in the present embodiment, an inspection interval, which is an interval between respective inspections, is output, but the inspection interval is not limited to this. For example, an inspection timing (an inspection period) such as how many days after the previous inspection (alternatively, at the start of the inspection,) an inspection should be performed, how many days after the start of an inspection each inspection should be performed, and an inspection date calculated based on an inspection interval may also be output.

Furthermore, some or all of the respective configurations, functions, the data input unit 101 to the Bayesian estimation unit 105, the storage device 113, etc. mentioned above may be realized by hardware, for example, by designing with an integrated circuit. In addition, as illustrated in FIG. 2, each of the above-described configurations, functions, etc. may be realized by software by interpreting and executing a program for realizing each function by a processor such as a CPU. Information such as programs, tables and files for realizing each function can be stored in a recording device such as the memory 111 or a solid state drive (SSD), or a recording medium such as an integrated circuit (IC) card, a secure digital (SD) card or a digital versatile disc (DVD) in addition to a hard disk (HD).

In addition, each embodiment illustrates control lines and information lines that are considered to be necessary for explanation, and does not necessarily illustrate all control lines and information lines in a product. In practice, it may be considered that almost all the configurations are connected to each other.

### REFERENCE SIGNS LIST

100 inspection assistance device
101 data input unit (input unit)
102 detection probability calculation unit
103 propagation analysis unit
104 inspection interval determination unit (inspection period determination unit, output processing unit)
105 Bayesian estimation unit
115 output device
202 inspection target
203 flaw
205 variation in installation position (inspection variation)
206 variation in ultrasonic wave transmission direction (inspection variation)
301 curve (flaw detection probability)
302 curve
304 region (region where flaw size probability distribution over time and fracture probability overlap)
305 curve (fracture probability)
311 curve (initial distribution of flaw size probability distribution)
312 curve (flaw size probability distribution over time)
321 curve (flaw size probability distribution after inspection)
401 dashed line (allowable risk)
331 curve (initial distribution of flaw size probability distribution in Weibull distribution)
332 curve (flaw size probability distribution over time in Weibull distribution)
S2 calculate flaw detection probability (first step)
S3 calculate flaw size probability distribution over time (second step)
S4 determination of inspection interval (third step)
S5 Bayesian estimation of flaw size probability distribution after inspection (fifth step)
S7 output all inspection intervals (fourth step)
S411 comparison between detection probability during inspection and upper limit detection probability (sixth step)

What is claimed is:

1. An inspection assistance method, comprising performing the following steps by an inspection assistance device:
a first step of calculating a flaw detection probability;
a second step of calculating a flaw size probability distribution over time using an inspection variation that has been input via an input unit and an initial distribution of the flaw size probability distribution; and
a third step of determining an inspection period in a case where an area of a region where the flaw size probability distribution over time and a fracture probability overlap with each other exceeds a preset allowable risk; and
a fourth step of outputting the determined inspection period.

2. The inspection assistance method according to claim 1, comprising:
a fifth step of estimating a flaw size probability distribution after inspection by Bayesian estimation using the flaw detection probability calculated in the first step and the flaw size probability distribution over time calculated in the second step,
wherein the inspection assistance device sequentially determines an inspection period by using the flaw size probability distribution after inspection calculated in the fifth step as an initial distribution of the flaw size probability distribution over time used in the second step.

3. The inspection assistance method according to claim 1, wherein the Bayesian estimation performed in the fifth step is calculated as the following Equation (1):
$$p ( a \vert after inspection ) = A ( 1 - POD ( a ) ) p ( a \vert before inspection ) \qquad ( 1 )$$
wherein in Equation (1), POD(a) is a flaw detection probability in a case where a flaw size is “a”, p(a|before inspection) is the flaw size probability distribution over time immediately before an inspection, and A is a normalization constant set so that a total probability becomes 1.

4. The inspection assistance method according to claim 1, wherein in the second step, a change over time in the flaw size probability distribution is a change over time of the flaw size probability distribution relating to a crack-like defect according to the Paris' law.

5. The inspection assistance method according to claim 1, wherein
the inspection assistance device conducts a sixth step of changing the initial distribution of the flaw size probability distribution in a case where a detection probability during inspection does not reach an upper limit detection probability that is a predetermined probability even the inspection is conducted a predetermined number of times in the third step.

6. The inspection assistance method according to claim 5, wherein the flaw size probability distribution is a Weibull distribution having a predetermined shape parameter, and a scale parameter, and
the inspection assistance device updates,
in the sixth step, the initial distribution of the flaw size probability distribution by changing the scale parameter, and performs the processing in and after the second step again.

7. The inspection assistance method according to claim 5, wherein the detection probability during inspection conforms to the following Equation (2):
$$\begin{matrix}[ Mathematical Equation 1 ] & \\ \frac{\partial p ( a , t )}{\partial t} = - \frac{\partial }{\partial a} [ μ ( a , t ) p ( a , t ) ] + \frac{1}{2} \frac{{\partial }^{2}}{\partial {a}^{2}} [ {σ ( a , t )}^{2} p ( a , t ) ] & ( 3 )\end{matrix}$$
wherein in Equation (2), POD(a) is the flaw detection probability calculated in the first step, and p(a|before inspection) is the flaw size probability distribution over time before inspection.

8. The inspection assistance method according to claim 1, wherein in the second step, the inspection assistance device calculates the flaw size probability distribution over time by solving a Fokker-Planck equation, which is a flaw propagation equation in which a flaw size is a continuous probability variable.

9. The inspection assistance method according to claim 1, wherein in the third step, the flaw size probability distribution over time is calculated by randomly sampling the flaw size and the flaw propagation speed.

10. An inspection assistance device, comprising:
a detection probability calculation unit configured to calculate a flaw detection probability;
a propagation analysis unit configured to calculate a flaw size probability distribution over time using an inspection variation that has been input via an input unit and an initial distribution of the flaw size probability distribution; and
an inspection period determination unit configured to determine an inspection period in a case where an area of a region where the flaw size probability distribution over time and a fracture probability overlap with each other exceeds a preset allowable risk; and
an output processing unit configured to output the determined inspection period.
